(19) United States
(12) Patent Application Publication
(10) Pub. No.: US 2014/0278839 A1
(43) Pub. Date: Sep. 18, 2014

(54) Location Based Payment System

(71) Applicants: Joe M. Lynam, Morgan Hill, CA (US); Evan B. Meyer, Danville, CA (US); Mark E. Snycerski, San Jose, CA (US)

(72) Inventors: Joe M. Lynam, Morgan Hill, CA (US); Evan B. Meyer, Danville, CA (US); Mark E. Snycerski, San Jose, CA (US)

(21) Appl. No.: 13/841,080

(22) Filed: Mar. 15, 2013

(51) Int. Cl. G06Q 20/32

(52) U.S. Cl. CPC G06Q 20/3276
USPC 705/13; 705/40

(57) ABSTRACT

At least one image, such as a QR code, taken by a camera of a mobile computing device is received. The at least one image includes an identifier of a location dependent good or service associate with the image. The location dependant service may be a service for using a parking space or charging an electric vehicle. The identifier is automatically extracted from the image, and a user is identified to pay for the good or service. The user may self identify himself by providing payment details, such as an account number, username, or login details, or the user may be automatically identified from his phone number, IP address, MAC address or any other unique user identifier. Thereafter, an account associated with the user, such as a debit or credit card account, is billed for the location dependent good or service associated with the extracted identifier.

### TECHNICAL FIELD

The present disclosure generally relates to enabling mobile transactions, and in particular, to systems, methods and devices for location based commercial transactions.

### BACKGROUND

There is a wide variety of commercial transactions that are tied to a particular geographic location. For example, as a matter of convenience and practicality, paying for parking one's vehicle (i.e., a parking related transaction) often occurs close to the particular parking location, space, lot or garage. These parking locations, spaces, lots or garages are typically scattered throughout a city and are typically operated by one or more private companies or a municipal agency.

There are two primary types of systems for collecting parking payments. A first system includes the placement of street-side parking meters, each of which is located on the curb alongside a corresponding parking space. The second system includes a multi-space parking meter, which can be used for both street-side parking and in parking lots or garages. Multi-space parking meters typically cost more than street-side parking meters on a per unit basis. However, street-side parking meters are typically deployed in greater numbers, so the aggregate cost associated with street-side parking meters is also typically high. There are also a number of operational costs associated with multi-space parking meters, such as fees for processing electronic payments and for delivering the payment information from the meter to the private company or municipal agency. These costs are either built into the parking fee or absorbed by the company or agency.

A common drawback of both of these systems is that payment terminals need to be provided close to the parking spaces in order to collect parking fees. Moreover, the payment terminals are costly to purchase, operate and maintain. Malfunctioning terminals lead to lost revenue because it is often not possible to collect payments for the use of parking spaces until the respective terminal is repaired. Parking terminals are also subject to theft and various forms of fraud. For example, coins or cash based parking meters can be broken into and the deposited money stolen. Fake coins or coins of another currency can be used to operate coin-based parking meters. In another example, an electronic terminal that accepts credit cards can be used to enable credit card fraud and/or identify theft by equipping an electronic terminal with a credit card reader that illicitly captures credit card information. Those skilled in the art will also appreciate that the aforementioned problems also apply to other types of location based transactions, such as those involving vending machines, public transportation, gas stations, ticketing services, or other remote purchases.

### SUMMARY

Various implementations of systems, methods and devices within the scope of the appended claims each have several aspects, no single one of which is solely responsible for the desirable attributes described herein. Without limiting the scope of the appended claims, some prominent features are described herein. After considering this discussion, and particularly after reading the section entitled “Detailed Description” one will understand how the features of various implementations are used to enable location based transactions.

One embodiment of the invention provides a method for facilitating a location based payment transaction. The method is performed at a system having a processor and memory containing instructions for execution by the processor, as described herein. In some embodiments this method is performed on a mobile computing device, such as a smartphone, while in other embodiments the method is performed on a service provider server. In yet other embodiments, the method is performed on multiple devices and/or servers.

At least one image taken by a camera of a mobile computing device is received. The at least one image includes an image of a QR code, a barcode, a vehicle license plate and/or the like. The at least one image includes an identifier of a location dependant good or service associate with the image. For example, the location dependant good or service may be a parking space, a vending machine, charge for an electric vehicle, payment for gas/petrol at a gas/petrol station, or the like. The identifier is automatically extracted from the image.

In some embodiments, an address of a webpage through which payment for the good or service can be made is decoded from the image. The webpage is then automatically launched so that the user can pay for the good or service through the webpage.

A user is then identified to pay for the good or service. The user may self identify himself by providing payment details, such as an account number, username, or login details, or the user may be automatically identified from his phone number, IP address, MAC address or any other unique user identifier. Thereafter, an account associated with the user (such as a debit or credit card account, or a stored balance on a user account associated with the user's phone) is billed for the location dependent good or service associated with the identifier.

Other embodiments provide a location based payment transaction system for performing the methods described herein. Still other embodiments provide a computer readable storage medium storing one or more programs configured for execution by a computer. The one or more programs include instructions for performing the methods described herein.

### BRIEF DESCRIPTION OF THE DRAWINGS

So that the present disclosure can be understood in greater detail, a more particular description may be had by reference to the features of various implementations, some of which are illustrated in the appended drawings. The appended drawings, however, merely illustrate the more pertinent features of the present disclosure and are therefore not to be considered limiting, for the description may admit to other effective features.

FIG. 1 is a diagram of a specific implementation of a mobile transaction processing environment.

FIG. 2 is a diagram of an implementation of a client device.

FIG. 3 is a diagram of an implementation of a service provider server system.

FIG. 4 is a diagram of an implementation of a verification server system.

FIG. 5 is a flowchart representation of client device method according to an employment of the invention.

FIG. 6 is a flowchart representation of a client device method according to another embodiment of the invention.

FIG. 7 is a flowchart representation of a client device method according to yet another embodiment of the invention.

FIG. 8 is a flowchart representation of a service provider server system method according to an embodiment of the invention.

FIG. 9 is a flowchart representation of a service provider server system method according to another embodiment of the invention.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

In contrast to prior methods of collecting parking revenue, and other related location based payment methods, implementations provided by the present disclosure enable location based payments that take advantage of the use of mobile computing devices, such as smartphones, tablet computers and the like. For example, as described below in greater detail, enabling users to pay for parking by using a smarthpone allows the operator of a parking lot or garage and/or a municipal agency to reduce, and possibly even eliminate, the use of parking meters to collect parking revenue. In some implementations, a sign with a machine readable image, such as a barcode or a QR (Quick Response) code is used to indicate the option to park and pay using a smartphone or the like.

Numerous details are described in order to provide a thorough understanding of the exemplary implementations described herein with reference to the accompanying drawings. However, various implementations may be configured and practiced without many of the specific details described below. Moreover, well-known methods, components, and circuits have not been described in exhaustive detail so as not to unnecessarily obscure more pertinent aspects of the implementations described herein.

FIG. 1 is a diagram of a specific implementation of a mobile transaction processing environment 100. While certain specific features are illustrated, those skilled in the art will appreciate from the present disclosure that various other features have not been illustrated for the sake of brevity and so as not to obscure more pertinent aspects of the implementations disclosed herein. To that end, the client-server environment 100 includes a retailer/service provider server 140, a verification service provider server 160, a mobile phone operator network 120 (e.g., carrier infrastructure), a mobile device 124 (e.g., smartphone) and a communications network 110 (e.g., the Internet). Each of the retailer server 140, the verification service provider server 160 and the mobile device 124 are capable of communication through a suitable combination of the operator network 120 and the communications network 110 in order to exchange information with one another and/or other devices and systems. Moreover, while FIG. 1 only includes one of each of the aforementioned devices and systems, those skilled in the art will appreciate from the present disclosure that any number of such devices and/or systems may be provided in a client-server environment, and particular devices may be altogether absent. In other words, the client-server environment 100 is merely an example provided to discuss more pertinent features of the present disclosure.

The network operator 120 is operable to connect client devices to the communications network 110. To that end, for example, the network operator 120 includes or is coupled to a radio network controller (RNC) 122 and a base station 123. Those skilled in the art will appreciate from the present disclosure that the carrier infrastructure of a mobile network typically includes, among many other well known devices, a number of RNC units that are each provisioned to manage a number of respective base stations. Additionally, a base station is typically provisioned to provide coverage to a geographic area within which subscribing mobile devices can access the mobile network. Accordingly, FIG. 1 merely illustrates the features of the carrier infrastructure of a mobile network pertinent to the implementations described in greater detail herein.

Additionally, the network operator 120 typically includes or is coupled to a gateway server 121 between the mobile network and an IP based communication network, such as the communications network 110. The gateway server 121 provides physical layer domain mapping between the mobile network and the IP based communication network, such as the Internet, so that data can be transferred between devices on both networks. For example, the mobile computing device 124 is operable on the network operator 120 of the mobile network, which includes for example, the base station 123 and the RNC 122. As such, data from the mobile computing device 124 that is destined for the service provider server 140 is first transmitted to the base station 123 serving the mobile communications device 124. The data is then passed up through the network operator 120 to the gateway 121 where it is mapped to a different physical layer infrastructure (typically using a different protocol) associated with the communication network 110 so that it can be routed to the retailer/service provider server 140 to complete the exemplary communication. In turn, an acknowledgment or other responsive communication is returned via the communication network 110 and through the gateway 121 using a complementary mapping technique so that the communication can be routed to the mobile computing device 124.

As would be appreciated by those skilled in the art, the communication network 110 may be an Internet protocol network, such as the Internet or a private network, and may be any combination of wired and wireless local area network (LAN) and/or wide area network (WAN), such as an intranet and/or an extranet. It is sufficient that the communication network 110 provides communication capability between various types of internet-enabled client devices, servers and database systems. In some implementations, the communication network 110 uses HyperText Transport Protocol (HTTP) to transport information using the Transmission Control Protocol/Internet Protocol (TCP/IP). HTTP permits a client device to access various resources available via the communication network. However, the various implementations described herein are not limited to the use of any particular protocol.

In some embodiments, retailer/service provider server 140 includes, for example, an online customer sales application server 141 and a database 142. In some implementations, the retailer/service provider server 140 is implemented as a single server system, while in other implementations it is implemented as a distributed system of multiple servers. Solely for convenience of explanation, the retailer/service provider server 140 is described below as being implemented on a single server system. Similarly, the verification service provider server 160 also includes, for example, an online verification server 161 and a database 162. In some implementations, the verification service provider server 160 is implemented as a single server system, while in other implementations it is implemented as a distributed system of multiple servers. Solely for convenience of explanation, the verification service provider server 160 is described below as being implemented on a single server system.

As discussed below in greater detail, client devices, such as the mobile computing device 124, are enabled to allow a user to make location dependent transactions, such as paying for parking. Each parking sign 111, 112 includes a respective machine readable image 111a, 112a that can be decoded by software operating on the mobile computing device and/or on a server. With further reference to FIG. 1, in some implementations, parking signs 111 and 112 are placed on or near corresponding parking spaces 111b and 112b. As described below with reference to the computer-implemented methods illustrated in FIGS. 5-9, a user-motorist can pay to park a vehicle 126 in one of the two parking spaces 111 and 112 using a transaction process that is coordinated between the retailer/service provider server 140 and the mobile computing device 140 and enabled by the machine readable images 111a, 112a on the parking signs 111 and 112.

In some embodiments, a near-field communication (NFC) chip or radio frequency identification (RFID) tag is used instead of, or in addition to, the machine readable image. In these embodiments, the NFC chip or RFID tag transfer a parking space identifier and/or other information, like charge per minute, to the user's phone. In yet other embodiments, instead of using a machine readable image, an identifier associated with the vehicle is used, such as an onboard Wi-Fi, MAC address, IP address, etc. This vehicle device ID can be linked to a user which in turn is linked to an account.

In yet another embodiment, instead of using a machine readable image, connection to a network in combination with a PIN is used for payment. For example, the user's device is detected on a Wi-Fi network or other network. If the device has been authorized when connected to the same network in the past, then an offer of a payment authorization is presented to the user who confirms the payment by entering a PIN.

FIG. 2 is a diagram of an implementation of the mobile computing device 124 of FIG. 1. While certain specific features are illustrated, those skilled in the art will appreciate from the present disclosure that various other features have not been illustrated for the sake of brevity and so as not to obscure more pertinent aspects of the implementations disclosed herein. As a non-limiting example, in some implementations the mobile computing device 124 includes one or more processing units (CPU's) 202, one or more network or other communications interfaces 208, a carrier network interface 207, a memory 205, a digital camera 209, and one or more communication buses 204 for interconnecting these and various other components.

The one or more communication buses 204 may include circuitry (sometimes called a chipset) that interconnect and control communications between system components. The memory 205 includes (i) high-speed random access memory, such as DRAM, SRAM, DDR RAM or other random access solid state memory devices; and/or (ii) non-volatile memory, such as one or more magnetic disk storage devices, optical disk storage devices, flash memory devices, or other non-volatile solid state storage devices. The memory 205 may optionally include one or more storage devices remotely located from the CPU(s) 202. The memory 205, including the non-volatile and/or volatile memory device(s) within the memory 205, comprises a non-transitory computer readable storage medium.

In some implementations, the memory 205, or the non-transitory computer readable storage medium of the memory 205, stores the following programs, modules and data structures, or a subset thereof, including: an operating system 210, a network communications controller 220, a verification processing module 230, one or more client applications 240, a GPS module 250, and an image processing module 260.

The operating system 210 includes procedures for handling various basic system services and for performing hardware dependent tasks. To that end, in some implementations, the operating system 210 stores and/or manages a number of device identifiers, including for example, a manufacturer device ID 212, a phone number 213 and a device registration number 214.

The communication controller 220 facilitates communication with other devices via the network interface 208 and the carrier network interface 207. To that end, in some implementations, the communication controller 220 stores and/or manages communication control information 221, including for example, a phone number 222, an IP address 223, carrier registration information 224, and ISP (Internet service provider) registration information 225.

The verification processing module 230 is configured to operate in accordance with instructions sent from a verification server (e.g. verification server 160 of FIG. 1) or a service provider server (e.g. retailer/service provider server 140 of FIG. 1), as discussed below with reference to FIGS. 5-9. To that end, the verification processing module 231 includes computer readable instructions 231, metadata 232 and transaction heuristics 233.

The one or more client applications 240 include applications, programs and/or user utilities that provide functionality on the mobile computing device 124. For example, the device 124 includes a web browser 241 and at least one server provider application 242, each of which may include a suitable combination of computer readable instructions, metadata and operation heuristics.

The GPS module 250 is optionally provided to enable the mobile computing device 124 to obtain location data by receiving GPS satellite signals. To that end, as would be understood by those skilled in the art the GPS module 250 includes computer readable instructions 251 and location data 252.

The image processing module 260 facilitates the capture and decoding of digital representations of machine readable images acquired by the camera module 209. To that end, the image processing module 260 includes a set of computer readable instructions 261, heuristics and metadata 262, and image data 263 provided by the camera module 209.

FIG. 3 is a diagram of an implementation of the service provider server system 140 shown in FIG. 1. While certain specific features are illustrated, those skilled in the art will appreciate from the present disclosure that various other features have not been illustrated for the sake of brevity and so as not to obscure more pertinent aspects of the example implementations disclosed herein. In some implementations, the service provider server system 140 is implemented as a single server system, while in other implementations it is implemented as a distributed system of multiple servers. For convenience of explanation herein, the service provider server system 140 is described below as being implemented on a single server system. To that end, as a non-limiting example, in some implementations the service provider server system 140 includes one or more processing units (CPU's) 302, one or more network or other communications interface(s) 308, a memory 305, and one or more communication buses 304 for interconnecting these and various other components.

The one or more communication buses 304 may include circuitry (sometimes called a chipset) that interconnect and control communications between system components. The memory 305 includes: (i) high-speed random access memory, such as DRAM, SRAM, DDR RAM or other random access solid state memory devices; and/or (ii) non-volatile memory, such as one or more magnetic disk storage devices, optical disk storage devices, flash memory devices, or other non-volatile solid state storage devices. The memory 305 may optionally include one or more storage devices remotely located from the CPU(s) 302. The memory 305, including the non-volatile and/or volatile memory device(s) within the memory 305, comprises a non-transitory computer readable storage medium.

In some implementations, the memory 305, or the non-transitory computer readable storage medium of the memory 305, stores the following programs, modules and data structures, or a subset thereof, including an operating system 310, a network communications controller 320, a transactions database 330, an image processing module 340, and a payment processing module 350.

The operating system 310 includes procedures for handling various basic system services and for performing hardware dependent tasks.

The communication controller 320 facilitates communication with other devices via the network interface 308. In some implementations, the communication controller 320 manages open sockets 321 with one or more client devices. Each socket number 322 is associated with an IP address 322a. The transactions database 330 is provided to store records of payments, along with location data transaction metadata and/or heuristics.

The image processing module 340 facilitates the decoding of digital representations of machine readable images acquired by a client device. To that end, the image processing module 340 includes a set of computer readable instructions 341, heuristics and/or metadata 342.

The payment processing module 350 is provided to process payments in coordination with a client device. To that end, the payment processing module 350 includes a verification processing module 360. In some implementations, the verification processing module 360 is configured to manage a payment verification process to reduce the potential for fraud and facilitate ease-of-service for location based transactions. To that end, the verification processing module 360 includes computer readable instructions 361, metadata 362, transaction heuristics 363, and inventory data 370. In some implementations, the inventory data 370 includes data about and associated with the products and/or services that may be purchased using a location based transaction.

For example, with reference to the parking payment example, the inventory data 370 includes data characterizing one or more parking spaces 371. In some implementations, such data includes GPS coordinates 371a, QR code data 371b (or another type of machine readable image), and miscellaneous vendor data 371c.

FIG. 4 is a diagram of an implementation of the verification server system 160 shown in FIG. 1. While certain specific features are illustrated, those skilled in the art will appreciate from the present disclosure that various other features have not been illustrated for the sake of brevity and so as not to obscure more pertinent aspects of the implementations disclosed herein. In some implementations, the verification server system 160 is implemented as a single server system, while in other implementations it is implemented as a distributed system of multiple servers. For convenience of explanation herein, the verification server system 160 is described below as being implemented on a single server system. To that end, as a non-limiting example, in some implementations the verification server system 160 includes one or more processing units (CPU's) 402, one or more network or other communications interfaces 408, a memory 405, and one or more communication buses 404 for interconnecting these and various other components.

In some implementations, the memory 405 or the non-transitory computer readable storage medium of the memory 405 stores the following programs, modules and data structures, or a subset thereof including an operating system 410, a network communications module 420, a carrier communication module 430, transaction processing module 440, and image processing module 480.

The operating system 410 includes procedures for handling various basic system services and for performing hardware dependent tasks.

The network communication module 420 facilitates IP data communication with other devices via the communication interface 408. The carrier communication module 430 facilitates communication on one or more mobile networks operated by respective carriers. To that end, the carrier communication module 430 stores and/or manages available carrier information 431, which includes individual carrier data 431-1 to 431-n.

The image processing module 480 facilitates the decoding of digital representations of machine readable images acquired by the mobile computing device 124. To that end, the image processing module 480 includes a set of computer readable instructions 481, heuristics and/or metadata 482.

The transaction processing module 440 is provided to facilitate transactions with particular client devices. To that end, the transaction processing module 440 includes computer readable instructions 441, metadata 442, heuristics 443, and/or transactions information 450. In some implementations, the transactions information 450 includes data for individual transactions 460, which includes client device data 461 and an authentication result 462. In some implementations, the device data 461 includes, for example, a manufacturer device ID 461a, a license plate number or image 461b, an IP address 461c and location data 461d. In some embodiments, the transaction processing module includes an authentication Result 462.

FIG. 5 is a flowchart representation of client system method 500 according to some embodiments of the indention. In some implementations, the method 500 is performed by a mobile computing device or the like. Briefly, the method includes instructing a mobile computing device to capture and decode an image of an operator provided machine readable image at a particular location, and enable the processing of a transaction based on the information encoded in the machine readable image.

To that end, as represented by block 501, the method 500 optionally includes receiving a user input initiating a mobile payment application. For example, with further reference to FIG. 1, a user provides an input that is received by the mobile computing device 124. In some implementations, the input includes a selection of an icon associated with a mobile payment application installed on the mobile computing device 124. In some implementations, the mobile computing device 124 includes at least one of a touch sensitive display and a keypad to receive the input as a physical contact or a detectable gesture. In some implementations, the mobile computing device 124 includes a microphone to receive the input as a voice and/or sound-based instruction from a user. In some implementations, as discussed below, the input includes user interaction with a web-browser and a website using the input devices associated with the mobile computing device 124.

In response receiving the input, as represented by block 502, the method 500 optionally includes prompting the user to take a photograph of the operator provided machine readable image or code associated with a parking space using the mobile computing device. As would be recognized by those skilled in the art, in some implementations, the machine readable image includes images such as a barcode, a data matrix, an EZ code, a high capacity color barcode, a data glyph, a QR code, a MaxiCode, a ShotCode and the like. In some implementations, the method includes displaying, on the screen of the mobile computing device at least one of a message and an instructional animation or movie prompting the user to take the picture. In some implementations, the method includes playing an audible sound or speech, using the speaker system of the mobile computing device, instructing the user to take the photograph.

In some implementations taking a photograph with a particular software application (e.g., a QR code application) launches a website for paying for parking (in this implementations, the user is not prompted to take a photograph at 502).

As represented by block 503, the method 500 includes receiving image data (e.g., the photograph of the code) from the camera module (e.g. camera 209 in FIG. 2) included in the mobile computing device. As represented by block 504, in some implementations, the method 500 includes extracting an identifier of the parking space (or other location specific payment) from the image provided by the camera module. In some implementations, the identifier is a unique sequence of alphanumerical characters, while in other implementations the identifier are the unique geographic coordinates associated with the parking space.

Additionally and/or alternatively, in some implementations, location data is received from a GPS unit included in the mobile computing device, and that location data is used to either identify the parking space location and/or verify the identifier received from the image. The aforementioned are merely examples of how an identifier of a parking space identifier can be acquired by a mobile application operating on a smartphone or the like. Those skilled in the art will appreciate from the present disclosure that there are also other methods for identifying the parking space, produce or service to be purchased, which have not be detailed for the sake of brevity and so as not to obscure more pertinent features of the implementations described herein.

As represented by block 505, the method 500 includes obtaining payment details from the user. For example, the user may input into the mobile computing device 124 the desired parking duration or monetary amount to be paid. The user may also enter other payment details, such as their preferred payment mechanism (credit or debit card) etc. In some implementations, the user's payment details, such as the user's preferred payment mechanism, is stored the first time the user uses the device and is not required each time a payment is made. The payment details may be stored on the device or server. In some implementations, the payment mechanism is a NFC chip that contains the user's payment details or that authorizes payment from an account associated with the user. In some implementations, the payment details are stored in a SIM card on the mobile computing device.

At step 506, the identifier and the payment details are sent from the mobile computing device to the service provider server. For example, with further reference to FIG. 1, the mobile computing device 124 transmits the identifier and the payment details to the service provider server 140. In some implementations, the user is simply instructed to take a photograph which is automatically sent to the service provider server and the determination of the parking space and/or its location is determined at the server.

As represented by block 507, the method 500 optionally includes receiving a pre-authorization to complete the transaction from the service provider server. As represented by block 508, the method 500 includes prompting the user to confirm the transaction. As represented by block 509, the method 500 includes determining whether the user provided an input confirming or rejecting the transaction. In some implementations, rejecting the transaction includes determining that the user has not provided an input in response to being prompted to confirm the transaction. In some implementations, rejecting the transaction includes receiving an input that indicates that the user wants to reject or cancel the transaction.

If the input (or lack thereof) indicates that the user has rejected the transaction (“No” path from 509), as represented by block 510, the method 500 includes aborting the transaction. In some implementations, aborting the transaction includes transmitting a message to the service provider server indicating that the user has terminated the transaction. In some implementations, aborting the transaction includes transmitting a socket close command to the service provider server to terminate the data connection with the server. On the other hand, if the input indicates a confirmation of the transaction (“Yes” path from 509), as represented by block 511, the method 500 includes transmitting a confirmation message to the service provider server. Additionally, as represented by block 512, the method 500 includes displaying a confirmation message to the user on the smartphone.

FIG. 6 is a flowchart representation of a client system method 600 according to another embodiment of the indention. In some implementations, the method 600 is performed by a mobile computing device or the like. Briefly, the method includes a user instructing a mobile computing device (or the like) to capture and decode an image of an operator provided machine readable image or code at a particular location, and enabling processing of a transaction by first launching a web browser based on the information encoded in the machine readable image.

To that end, as represented by block 601, the method 600 optionally includes receiving a user input initiating a mobile payment processing request. For example, with further reference to FIG. 1, a user provides an input that is received by the mobile computing device 124. In some implementations, the mobile computing device 124 includes at least one of a touch sensitive display and a keypad to receive the input as a physical contact or a detectable gesture. In some implementations, the mobile computing device 124 includes a microphone to receive the input as a voice and/or sound-based instruction from a user. In some implementations, as discussed below, the input includes the selection of a web-browser and a website using the input devices associated with the mobile computing device 124.

In response receiving the input, as represented by block 602, the method 600 optionally includes prompting the user to take a picture of the operator provided machine readable image associated with a parking space using the smartphone. In some implementations, the method includes playing an audible instruction prompting the user to take the picture using the speaker system of the mobile computing device. In other implementations, a sign at the parking space prompts the user to take a photograph and send it to a particular address.

As represented by block 603, the method 600 includes receiving image data from the camera module (e.g. camera 209 in FIG. 2) included in the smartphone. As represented by block 604, the method 600 includes extracting and decoding the machine readable image or code from the image provided by the camera module. The extracted or decoded data includes an address and an identifier of the parking space. As represented by block 605, the method 600 then launches a web browser or opening a socket with the service provider server based on an address and identifier embedded in the code (e.g., a URL embedded in a QR code) to establish a data connection with the service provider server. As represented by block 606, payment details are then acquired from the user through the launched webpage and transmitted to the service provider. In some implementations, the identifier is only transmitted to the service provider with the payment details.

As represented by block 607, the method 600 includes prompting the user to confirm the transaction. As represented by block 608, the method 600 includes determining whether the user provided an input confirming or rejecting the transaction. If the input (or lack thereof) indicates that the user has rejected the transaction (“No” path from 608), as represented by block 609, the method 600 includes aborting the transaction. On the other hand, if the input indicates a confirmation of the transactions (“Yes” path from 608), as represented by block 610, the method 600 includes transmitting location data and a portion of the decoded QR code data to the service provider server. In response, as represented by block 611, the method 600 includes receiving a payment confirmation message from the service provider server. As represented by block 612, the method 600 includes displaying a confirmation message to the user on the smartphone.

FIG. 7 is a flowchart representation of a client system method 700 according to yet another embodiment of the invention. In some implementations, the method 700 is performed by a mobile computing device or the like. Briefly, the method includes instructing a mobile computing device to capture and decode an image of an operator provided machine readable image or code at a particular location, and enabling processing of a transaction based on the information encoded in the machine readable image and a license plate number associated with a user. To that end, as represented by block 701, the method 700 optionally includes receiving a user input initiating a mobile payment application. As represented by block 702, the method 700 optionally includes prompting the user to take a picture of the operator provided machine readable image associated with a parking space using the smartphone. As represented by block 703, the method 700 includes receiving image data from the camera module (e.g. camera 209 in FIG. 2) included in the smartphone.

As represented by block 704, the method 700 includes extracting an identifier from the code, as described above. The user is then optionally prompted to take a photograph of his/her vehicle's license plate at 705. As represented by block 706, in some implementations, the method 700 includes extracting the license plate data from the image data received from the camera module. In some implementations, extracting the license plate data from the image data includes processing the image data using an optical character recognition method. In some implementations, extracting the license plate data occurs on the server. In yet other embodiments, user takes a photograph of the car. A parking enforcer can use the photograph of the car to locate a vehicle from a further distance than a license plate. In other words, the payment and the location are linked to the photograph of the car. For example, a user can take a photograph of their vehicle with GPS coordinates associated with the photograph. In some embodiments, the photograph is taken with a dedicated payment application on the user's phone. The user is then presented with the price per unit of time. Thereafter, the user confirms payment with a linked account (e.g., mobile phone, credit card, debit account, etc.) The application can also be used to locate the user's vehicle, i.e., direct the user back to their parking location.

A meter app could optimize collection routes using the highest concentration of expired meters. Plot a course using a map with real-time expired meter updates. Perhaps only make right turns for collection.

As described above, the user's payment details are then acquired at 707, and the identifier, payment details, and license plate photo or extracted data are then sent to the service provider at 708. The license plate photograph or data is used to verify the identity of the user and or locate payment details on the server. In response, as represented by block 709, the method 700 includes receiving a confirmation message from the service provider server. Additionally, as represented by block 710, the method 700 includes displaying a confirmation message to the user on the smartphone.

FIG. 8 is a flowchart representation of a service provider system method 800 according to some embodiments of the invention. In some implementations, the method 800 is performed by a service provider server or a verification server operated by a parking lot operator (e.g., a private company or municipal agency) or another type of service provider or retailer providing the option for location based transactions. Briefly, the method includes receiving a request to pay for the use of a parking space or the like, and conducting the transaction using a combination of any of the following: an identifier, a photograph, location data, and operator data provided near the location where the transaction is occurring. As described above, in some implementations, the operator data is encoded in a machine readable image that can be decoded by a smartphone or the like.

To that end, as represented by block 801, the method 800 includes receiving a payment request from a client device such as a smartphone. In some implementations, the payment request is received from a mobile application operating on a mobile computing device, such as a smartphone or the like. In some implementations, the payment request is received from a web server accessible by a web browser operating on the client device. In some implementations, a request for a photograph of the code (e.g. a QR code) provided near the parking space, payment details, and/or a parking space identifier is sent to the user at 802. As represented by block 803, the method 800 includes receiving the photograph, identifier, and/or payment details. Alternatively, in some implementations, the server receives image data—including a representation of the machine readable image—captured by the client device, and subsequently extracts the location data and the data from the representation of the machine readable image. In some implementations, the GPS location of the mobile computing device is also received by the server.

As represented by block 804, the method 800 includes determining whether the identifier matches an identifier stored in a database, e.g., that the parking space identifier is for a known parking space that is available. In some implementations, the option to determine whether the identifier matches the GPS location is employed as a security feature that may reduce fraud by placing the mobile client device at the parking location. In other words, the GPS location may be used to identify the user and/or the location. If the identifier does not match an existing identifier (and/or if the user is not at a location associated with the identifier) (“No” path from 804), as represented by block 805, the method 800 includes transmitting an error message to the client device and ending the transaction. In some implementations, a fraud report may be created and transmitted to a credit card company, bank or a third party monitoring agency. If the identifier matches an existing identifier (and/or if the user is at a location associated with the identifier) (“Yes” path from 804), as represented by block 806, the method 800 includes retrieving a user billing preference using a phone number (or another user identifier such as an email, login ID, IP address etc.). In some implementations, the billing preference indicates how a user has chosen to be billed. For example, in some implementations, the billing preference is used to specify that the user has previously chosen to bill transactions to one of a credit card, a debit card, a bank account, or add the charge for parking to a bill associated with a utility such as a phone bill, a gas bill, an electric bill etc.

In some embodiments, the user may be pre-authorized at specific GPS coordinates. In other words, all the user needs to do is arrive at a specific location and confirm payment. The system contains information that automatically authenticates payment at one or more predetermined locations.

As represented by block 807, the method 800 includes obtaining a billing pre-authorization from a payment processing server. In some implementations, the payment processing server is associated with at least one of credit card billing agency, a bank and a utility company. As represented by block 808, the method 800 includes transmitting the billing pre-authorization to the client device to inform the user that the transaction can be approved if the user provides an input confirming that the user has chosen to proceed with the transaction. As such, as represented by block 809, the method 800 includes receiving a payment confirmation message from the client device, which includes an instruction from the user whether or not to proceed with the transaction. As represented by block 810, the method 800 includes determining whether or not the confirmation message includes an instruction to proceed with the transaction. If the confirmation message includes an instruction to proceed with the transaction (“Yes” path from 810), as represented by block 811, the method 800 includes transmitting a billing amount confirmation to the verification server. On the other hand, if the confirmation message includes an instruction to cancel the transaction, as represented by block 812, the method 800 includes transmitting a pre-authorization cancellation message to the verification server.

FIG. 9 is a flowchart representation of a service provider system method 900 according to another embodiment of the invention. In some implementations, the method 900 is performed by a service provider server or a verification server operated by a parking lot operator (e.g., a private company or municipal agency) or another type of service provider or retailer providing the option for location based transactions. Briefly, the method includes receiving a request to pay for the use of a parking space, and conducting the transaction using a combination of location data, operator data provided near the location where the transaction is occurring, and a license plate number of vehicle. As described above, in some implementations, the operator data is encoded in a machine readable image that can be decoded by a smartphone or the like.

To that end, as represented by block 901, the method 900 includes receiving a payment request from a client device such as a smartphone. As represented by block 902, the method 900 includes transmitting a request for a photograph of the code at the parking space, or an identifier associated with the parking space, payment details (e.g., duration) and/or a photograph of the license plate number of the vehicle that will occupy the parking space for the duration being paid for. In some implementations, the GPS location of the device is also requested. As such, in some implementations, payment for the use of a particular parking space is tied to the combination of the particular parking space and a vehicle identified by a respective license plate number. Consequently, a second user of another vehicle that subsequently uses the parking space will also have to pay for the use of the space even if the use of the parking space has been previously paid for by a first user that has left the space open for another to park.

As represented by block 903, the method 900 includes receiving at least some of the requested data from the client device. As represented by block 904, the method 900 includes retrieving a user billing preference using a license plate number (or another user identifier such as an email, a phone number or a login ID). As represented by block 905, the method 900 includes obtaining a billing pre-authorization from a payment processing server. As represented by block 906, the method 900 includes transmitting the billing pre-authorization to the client device to inform the user that the transaction can be approved if the user provides an input confirming that the user has chosen to proceed with the transaction. As such, as represented by block 907, the method 900 includes receiving a payment confirmation message from the client device, which includes an indication from the user confirming the transaction. As represented by block 908, the method 900 includes transmitting a billing amount confirmation to the verification server.

While the above embodiments were described in terms of paying for the use of a parking space, the same system and method can be used for any other location based payments. For example, payment for receiving an electrical charge for an electric vehicle etc.

In yet other embodiments, multi-factor authentication can be used. For example, the use of a smartphone plus wearable device used for more robust authentication. The wearable devices may include a watch, eye glasses, ear piece, belt, or other wearable component with a tethered or wireless connection to the smartphone. PIN codes can also be added for additional security. In some embodiments, multi-factor authentication is used for higher priced items, i.e., as the price increases, more authentication steps are needed.

In yet other embodiments, additional authentication may incorporate biometric sensors (e.g., thumb/finger scan, iris detection, heartbeat, temperature, cardiac rhythms etc.). For example, a camera may be used to perform facial recognition or detect heart rate by measuring the slight color change as blood is pumped through blood vessels. For higher priced items, the camera is used to take a photograph and/or video that is manually authenticated by a remote call center. The GPS coordinates of the picture may be used to trigger one or more additional authentication checks (e.g., users that are far from their home or in a new location require more authentication). Once authenticated, the GPS coordinates are saved so that future visits to the same location require fewer authentication steps.

It will also be understood that, although the terms “first,” “second,” etc. may be used herein to describe various elements, these elements should not be limited by these terms. The terminology used herein is for the purpose of describing particular embodiments only and is not intended to be limiting of the claims. As used in the description of the embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. For example, some embodiments may only use (i) the location of the user (as obtained from a GPS sensor in the user's phone) to identify the location based good or service, and (ii) the user's telephone number to identify the user, to pay for a specific location based good or service. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method for facilitating a location based payment transaction, the method comprising:
at a system having a processor and memory containing instructions for execution by the processor:
receiving at least one image taken by a camera of a mobile computing device of a QR code, where the at least one image includes an identifier of a parking space associated with the QR code;
automatically without human intervention extracting the identifier from the image;
identifying a user to pay for the good or service; and
facilitating billing an account associated with the user for the location dependent good or service associated with the identifier.

2. The method of claim 1, wherein the system is the mobile computing device.

3. The method of claim 1, wherein the system is a service provider server disposed remotely from the mobile computing device.

4. The method of claim 1, wherein the extracting further comprises decoding an address of a webpage through which payment for the good or service can be made, and further comprising, prior to facilitating the billing, automatically without human intervention launching the webpage.

5. The method of claim 1, wherein the identifying comprises obtaining payment details from the user.

6. A method for facilitating a location based payment transaction, the method comprising:
at a system having a processor and memory containing instructions for execution by the processor:
receiving at least one image taken by a mobile computing device, where the at least one image includes embedded data comprising an identifier of a location dependant good or service;
extracting the data from the image;
identifying a user to pay for the good or service; and
facilitating billing an account associated with the user for the location dependent good or service associated with the identifier.

7. The method of claim 6, wherein the image is a photograph of a QR code taken by a camera of the mobile computing device.

8. The method of claim 6, wherein the system is the mobile computing device.

9. The method of claim 6, wherein the system is a service provider server disposed remotely from the mobile computing device.

10. The method of claim 6, wherein the location dependant good or service is a parking space.

11. The method of claim 6, wherein the extracting comprises decoding the image to determine a unique identifier associated with the location dependant good or service, and decoding an address of a webpage through which payment for the good or service can be made.

12. The method of claim 11, further comprising, prior to the facilitating, automatically without human intervention, launching the webpage so that the user can pay for the good or service.

13. The method of claim 6, wherein the extracting is performed automatically without human intervention.

14. The method of claim 6, wherein the identifying comprises obtaining payment details from the user.

15. The method of claim 6, wherein the at least one image also includes an image of a license plate of a vehicle associated with the user, and identification of the user is made using the image of the license plate.

16. The method of claim 15, further comprising performing optical character recognition of the image of the license plate to be used in determining the identification of the user.

17. The method of claim 6, wherein previously stored payment details are obtained using the identity of the user.

18. The method of claim 6, facilitating billing an account associated with the user comprises debiting a credit or debit card associated with the user, or debiting a stored balance on an account associated with the user's phone.

19. A location based payment transaction system comprising:
a processor;
a memory coupled to the processor, the memory comprising instructions for:
receiving an image taken by a mobile computing device, where said image includes embedded data comprising an identifier of a location dependant good or service;
extracting the data from the image;
identifying a user to pay for the good or service; and
facilitating billing an account associated with the user for the location dependent good or service associated with the identifier.

20. A computer readable storage medium storing one or more programs configured for execution by a computer, the one or more programs comprising instructions for:
receiving an image taken by a mobile computing device, where said image includes embedded data comprising an identifier of a location dependant good or service;
extracting the data from the image;
identifying a user to pay for the good or service; and
facilitating billing an account associated with the user for the location dependent good or service associated with the identifier.
